(19) United States
(12) Patent Application Publication
(10) Pub. No.: US 2016/0125501 A1
(43) Pub. Date: May 5, 2016

(54) PREFERENCE-ELICITATION FRAMEWORK FOR REAL-TIME PERSONALIZED RECOMMENDATION

(71) Applicants: Philippe NEMERY, Shanghai (CN); Boyi NI, Shanghai (CN); Wen-Syan LI, Fremont, CA (US)

(72) Inventors: Philippe NEMERY, Shanghai (CN); Boyi NI, Shanghai (CN); Wen-Syan LI, Fremont, CA (US)

(21) Appl. No.: 14/532,677

(22) Filed: Nov. 4, 2014

(51) Int. Cl. G06Q 30/06; G06N 99/00; G06N 7/00; G06F 17/30; G06N 5/04

(52) U.S. Cl. CPC G06Q 30/0631; G06F 17/3053; G06N 5/045; G06N 7/00; G06N 99/005

(57) ABSTRACT

A system includes an option selection engine selects an initial subset of pre-selected products from multiple products for display to a user, where the products include multiple filtering options and multiple selection criteria. An elicitation engine prompts the user to provide input including input for the filtering options and input for the selection criteria and receives the filtering options input and the selection criteria input. A ranking and scoring engine receives the filtering options input and the selection criteria input and selects one method of multiple methods to calculate a score for the products and to rank the products using the score based on the filtering options input and the selection criteria input from the user. An option selection engine selects an updated subset of products from the plurality of products for display to the user based on the rank of the of the products using the score.

### TECHNICAL FIELD

This description relates to a system and techniques for a preference-elicitation framework for real-time personalized recommendation.

### BACKGROUND

E-commerce websites have the possibility to offer a potential consumer many different variants of a same product, which makes the decision process for a consumer sometimes cumbersome. Scrolling through the pages of similar products requires time and patience for the consumer and it is not always easy to understand the differences between the products. Moreover, few methods exist to bring all the available information about the products or services in a convenient way. The presentation of the information may be poor such that easy comparison is not possible.

### SUMMARY

According to one general aspect, a system for providing personalized product recommendations to a user includes at least one memory including instructions and at least one processor that is operably coupled to the at least one memory and that is arranged and configured to execute the instructions that, when executed, cause the at least one processor to implement an option selection engine, an elicitation engine and a ranking and scoring engine. The option selection engine selects an initial subset of pre-selected products from multiple products for display to a user, where the products include multiple filtering options and multiple selection criteria. The elicitation engine prompts the user to provide input including input for the filtering options and input for the selection criteria and receives the filtering options input and the selection criteria input. The ranking and scoring engine receives the filtering options input and the selection criteria input and selects one method of multiple methods to calculate a score for the products and to rank the products using the score based on the filtering options input and the selection criteria input from the user. The option selection engine selects an updated subset of products from the plurality of products for display to the user based on the rank of the of the products using the score.

In another general aspect, a computer program product is tangibly embodied on a non-transitory computer-readable storage medium and includes instructions that, when executed, are configured to cause at least one processor to select an initial subset of pre-selected products from multiple for display to a user using a computing device, where the products includes multiple filtering options and multiple selection criteria. The user is prompted to provide input including at least one of input for the filtering options and input for the selection criteria and the filtering options input and the selection criteria input are received from the user. The filtering options input and the selection criteria input are received and one method of multiple methods is selected to calculate a score for the products and to rank the products using the score based on the filtering options input and the selection criteria input from the user. An updated subset of products is selected from the multiple products for display to the user based on the rank of the of the products using the score.

In another general aspect, a computer-implemented method for executing instructions stored on a non-transitory computer-readable storage medium includes selecting an initial subset of pre-selected products from multiple products for display to a user using a computing device, where the multiple products includes multiple filtering options and multiple selection criteria, prompting the user to provide input including at least one of input for the filtering options and input for the selection criteria, receiving the filtering options input and the selection criteria input and selecting one method of multiple methods to calculate a score for the products and to rank the products using the score based on the filtering options input and the selection criteria input from the user, and selecting an updated subset of products from the multiple products for display to the user based on the rank of the of the products using the score.

The details of one or more implementations are set forth in the accompanying drawings and the description below. Other features will be apparent from the description and drawings, and from the claims.

### BRIEF DESCRIPTION OF THE DRAWINGS

FIG. 1 is an example block diagram of an example system for providing personalized product recommendations to a user.

FIG. 2 is an example flowchart illustrating example operations for the system of FIG. 1.

FIG. 3 is an example schematic of an example representation of the different subset of options for an example product.

FIG. 4 is an example block diagram of an example flow of user inputs and system processing of the user inputs.

FIG. 5 is an example screen shot of an example e-commerce website.

FIG. 6 is an example screen shot of an example e-commerce website.

FIG. 7 is an example block diagram of an example flow of user preference elicitation.

FIG. 8 are example graphs of a user's evaluation of criterion.

FIG. 9 is an example schematic of an example decision tree.

FIG. 10 is an example table of product options and associated scores.

FIG. 11 is an example table of features and associated weights.

FIG. 12 is an example of a decision tree presented to a user.

FIG. 13 is an example screen shot of a product and associated features.

### DETAILED DESCRIPTION

This document describes a system and techniques for providing personalized product recommendations to a user based on information elicited from the user about the product or other products, including related products. The system and techniques elicit user likes and dislikes for product options, filtering options for the product and selection criteria for the product. Based on the elicited information, the system and techniques scores and ranks the product options for display to the user. The displayed information may include displaying the scores and ranks of the product options to the user. The displayed information also may include the relevant features/attributes of the product along with the associated weight of the features/attributes to illustrate the importance of the feature to the user. Furthermore, the displayed information may include an illustration of the decision tree path for a particular product option.

The system may receive additional real-time product option rating information from the user and the system may iteratively update the score and the rank of the product options for display to the user. The iterative updates to the score and the rank of the product options may be performed each time the user interacts with the system and provide additional feedback to the system. In this manner, the scoring and ranking of the product options provided to the user is based on information elicited from the user about the product. The scoring and ranking product options are not based on historic statistical information about the products themselves, but instead are based on individualized user preferences that have been provided by the user about the product.

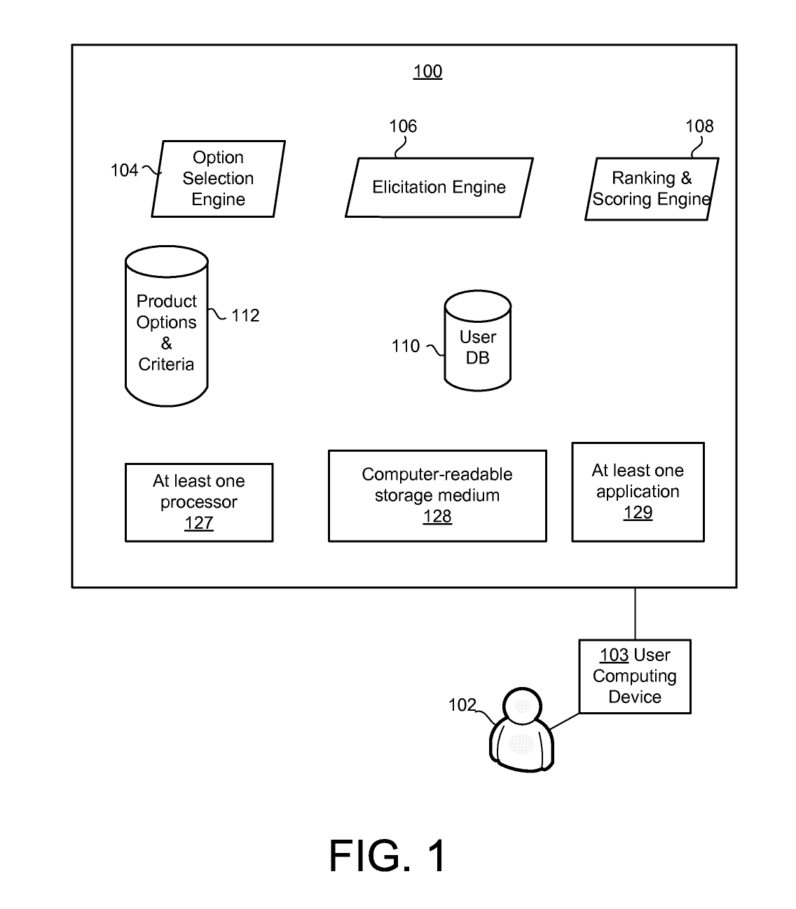

Referring to FIG. 1, an example block diagram illustrates a system 100 for providing personalized product recommendations to a user 102 using a user computing device 103. The system 100 includes an option selection engine 104, an elicitation engine 106, a ranking and scoring engine 108 and a user profile database 110. The system 100 also may be referred to as a global recommender system. Thus, not only may the system 100 be used to provide personalized product recommendations to a user, the system 100 may be tailored to provide other types of personalized recommendations to the user as well. The components of the system 100 may be operably connected to one another to enable wired and/or wireless communications with one another. In one implementation, the system 100 may be implemented on a computing device such as, for instance, a server.

The option selection engine 104 may initially provide a subset of products (also referred to as product options) from multiple products for display to the user 102 on the user computing device 103. For example, the user 102 using the user computing device 103 may navigate to an e-commerce website using a browser application or other application. The system 100 may host the e-commerce website or, alternatively, may communicate with a computing device hosting the e-commerce website over a network connection. In one example, the user 102 may navigate to the e-commerce website and browse a television product category and/or search for televisions. The option selection engine 104 may select a subset of televisions (also referred to as television options) from multiple televisions. Of course, the example of televisions is merely one example product and the system is designed to work with all different products and e-commerce websites.

The system 100 also may interact with a product options and criteria database 112, which may be optionally implemented as part of the system 100. If the system 100 is hosting the e-commerce website, then the product options and criteria database 112 may be part of the system 100. If the system 100 does not host the e-commerce website, then the product options and criteria database 112 may not be a part of the system 100 but may be a part of the e-commerce web host system, which may be accessible by the system 100. The product options and criteria database 112 may include a database of products including product options and product criteria. The products options may also be referred to as product features and/or product attributes.

In other implementations, even if the system 100 does not host the e-commerce website, then the product options and criteria database 112 may still be used. For instance, the product options and criteria database 112 may include product features and/or product attributes that may be applicable to products that are a part of a different e-commerce website.

The initial subset of products may be selected by the option selection engine 104 for display to the user using different methods. In one implementation, the first time a user connects to the e-commerce website that leverages the system 100, the system 100 may not have any personal preference data from the user. That is, the user profile database 110 may not include any information about product feature preferences or selection criteria regarding any products. The option selection engine 104 may cause to display products based on historical data such as, for example, the most purchased products, most viewed products, and/or the highest rated products. These recommendations by the option selection engine 104 are not personalized to the user but will be refined later by the subsequent user interactions.

In another example implementation, the system 100 may include some information about the user's preferences, but maybe not for the specific product being viewed. The information about the user's preferences may be from previous interactions with the user with other products and this information may be stored in the user profile database 110. The option selection engine 104 in this example may leverage the user preference information stored in the user profile database 110 to recommend and display an initial subset of product options based on this stored preference information specific to the user. Again, these recommendations are more personalized than if the system had no information about the user preferences, but these recommendations are not personalized for the particular product of interest so the recommendations will be refined later by the subsequent user interactions.

The option selection engine 104 may recommend and display (or cause to display) the initial subset of products, which may be a fraction of the total number of products available for display. Instead of displaying all potential products in a table, grid or listing, the option selection engine 104 selects just a subset of products from all potential products to recommend and display to the user 102.

Once the initial subset of products is displayed to the user, the system 100 elicits preferences from the user 102 through the user computing device 103. The elicited preferences are used to refine the product recommendations and to display a different subset of products based on the elicited preferences. The more preference and criteria information provided by the user 102, then the system 100 can provide more refined and accurate product recommendations. The system 100 can provide refined product recommendations based on various different amounts of elicited preferences. The system 100 may refine product recommendations in a recursive manner as the user continues to interact with the system and provide additional information for the system to use in refining the product recommendations.

The elicitation engine 106 is configured to prompt the user to provide input to elicit preference information from the user. The elicitation engine 106 is configured to proactively discover the preferences of the user in various ways, including prompting the user to input if he/she likes or dislikes displayed products initially chosen by the system 100. Based on this given information, the system 100 through the elicitation engine 106 will first extract or elicit the user's preference information about the product type or category. This preference information is used in a second phase to rank and/or score all the considered products. These rankings and scores reflect the user's preferences and enable the user to find a best product match in a quick and user-friendly manner.

The system 100 includes at least one processor 127, a non-transitory computer-readable storage medium 128, and at least one application 129. The system 100 may be implemented on a computing device, which may include any type of computing device including, for example, a server, a blade server, a desktop, a laptop, or any other computing device. The computing device may include multiple computing devices, such as, multiple servers, that are operably coupled and configured to host the components of the system across the multiple computing devices. The computing device may be networked to other computing devices (not shown) such that the systems on the computing device may send and receive information across a network (not shown), such as the Internet, a wide area network and/or a local area network.

Thus, the at least one processor 127 may represent two or more processors executing in parallel, and a non-transitory computer-readable storage medium 128 may represent virtually any non-transitory medium that may be used to store instructions for executing the components of system 100, including the at least one application 129. Multiple processors also may be referred to as multi-core processors or multi-processor core environment. The processor 127 may be a hardware processor, including a micro-processor.

The at least one processor 127 may be configured to execute instructions stored on the computer-readable storage medium 128 that, when executed, cause the at least one processor 127 to implement the option selection engine 104, the elicitation engine 106 and the ranking and scoring engine 108.

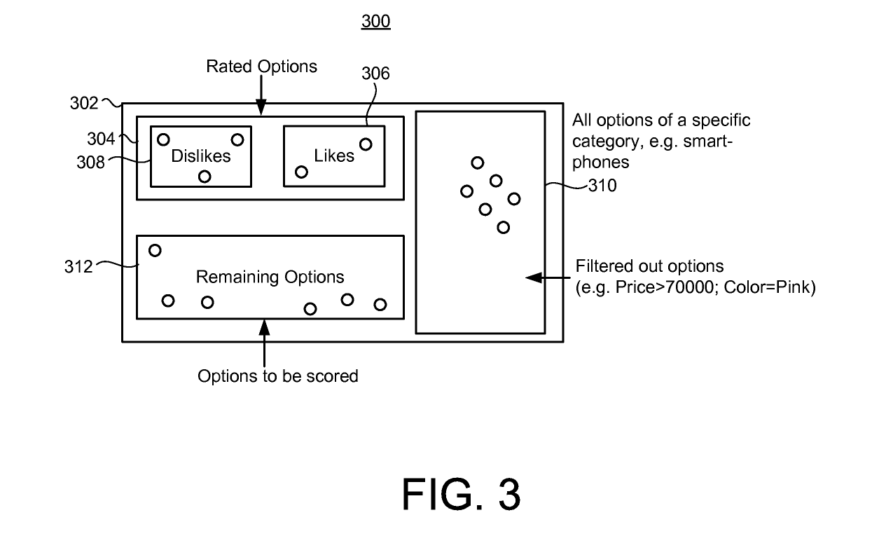

Referring also to FIG. 3, example schematic 300 illustrates an example representation of the different subset of options for an example product. The schematic 300 illustrates a grouping 302 of all options of a product (also referred to as a category, product category or a specific category). In this example, the product category is smartphones. From the grouping 302 of all of the options, the option selection engine 104 selects an initial subset 304 of product to display to the user. The elicitation engine 106 prompts the user to enter some initial preferences including filtering options and/or selection criteria. The initial input elicited by the user may simply be asking the user to like 306 or dislike 308 the initial subset of displayed products.

The initial input of like 306 and dislike 308 may be used by the system 100 to filter out some product options 310. For example, the filtered out options 310 may be filtered out from consideration based on similarities of features with the disliked options 308. Then, the remaining product options 312 may be scored and ranked by the ranking and scoring engine 108. The remaining product options to be scored may include the like options 306 as well as other product options that include features similar to those of the like options 306. As the user interacts with the system 100, for example, by indicating likes and dislikes, the system 100 may refine the remaining options 312 with each user interaction, including scoring and ranking the remaining options 312 with each user interaction. In this manner, the recommender system provides real-time interactive and personalized recommendations While this example is illustrated with respect to smartphones, it applies equally to many other product categories.

Referring back to FIG. 1, the elicitation engine 106 is configured to receive filtering options input and/or selection criteria input from the user 102 through the user computing device 103. The filtering options may include different features or attributes related to the specific product. The list of filtering options may be provided from the product options and criteria database 112. The filtering options input may include features such as brand, size, color, price range, etc. These are just a few examples of the filtering options and many other types of filtering options may be used that are specific to a particular product. The elicitation engine 106 may select one or more of the filtering options to display and prompt the user for input without overwhelming the user with an unlimited number of filtering options to sort through and select.

The selection criteria may include a listing or other presentation of the features to enable the user to select which of the features are most important to the user. The selection criteria may be selected by the elicitation engine 106 for display to the user to elicit which criteria is important to the user as related to the product.

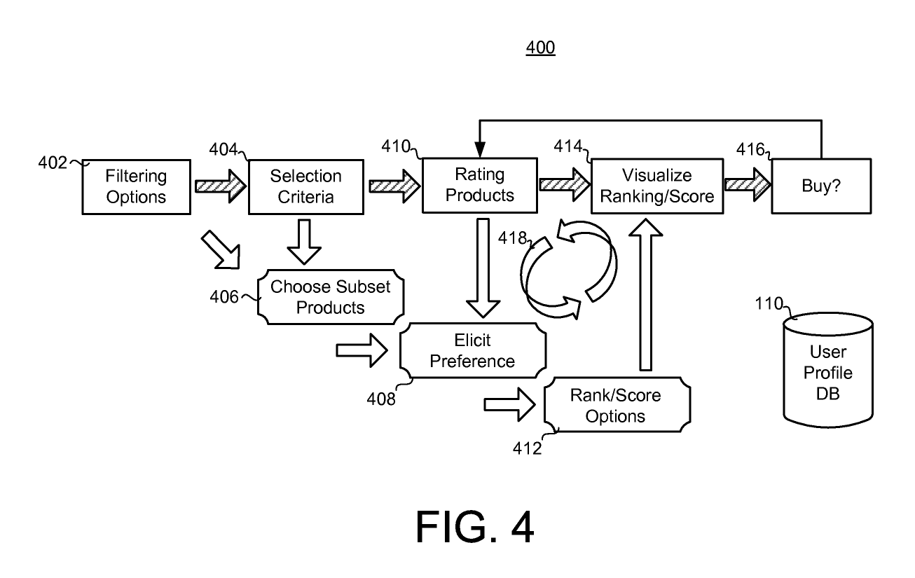

Referring also to FIG. 4, an example block diagram illustrates an example flow 400 of user inputs and system processing of the user inputs. The elicitation engine 106 may prompt the user to input filtering options 402 and selection criteria 404. The user may choose whether or not to input filtering options 402 and/or selection criteria 404. Based on the received initial filtering options 402 and the selection criteria 404, the option selection engine 104 may choose a subset of the products 406 to display to the user. In one example implementation, the selection of a subset of the products 406 may be a further selection of product recommendations following the initial subset of product recommendations. In other example implementations, the user may first provide filtering option 402 and/or selection criteria 404 input and then the option selection engine 104 may choose the subset of products 406 to display.

The elicitation engine 106 may elicit preferences 408 from the user by prompting the user to rate the displayed subset of products 410. For example, the elicitation engine 106 may prompt the user to provide a binary input to rate the products such as like or dislike (or other similar binary rating input). The binary input may include enabling the user to select a graphic of a thumbs up (i.e., like) or a thumbs down (i.e., dislike) or other similar graphic that represents the binary rating options. In other examples, the elicitation engine 106 may prompt the user to provide a ranking based on a scale (e.g., 1 to 10) of the displayed product.

The ranking and scoring engine 108 may be configured to receive the elicited preference information including the filtering options 402, the selection criteria 404 and the rating information 410. The ranking and scoring engine 108 may select one of multiple methods to calculate a score for the products and to rank the products 412 using the score based on the elicited preferences. The selected method to score and rank the products 412 may be based on an amount and/or type of information elicited from the user. The elicitation engine 106 may transform the elicited preferences into preference parameters, which are used by the ranking and scoring engine 108 for scoring/ranking the products.

In one implementation, the ranking and scoring engine 108 may score and rank all of the product options. In other implementations, the ranking and scoring engine 108 may score only the product options remaining after some of the products have been filtered out based on the filtering options provided by the user.

The scored and ranked products may be displayed to the user by the option selection engine 104 based on the rank of the products using the score. The option selection engine 104 may include the score along with the product so that the user can visualize the score.

The user may continue to interact with the system 100 and continue to provide information on the displayed products 416. As the user provides additional information and preferences, the elicitation engine 106 updates the preference parameters 408 and the ranking and scoring engine 108 updates the scoring and ranking of the products 412. The option selection engine 104 displays updated product recommendations for visualization of the products and their scores to the user 414. This iterative process 418 may continue until, for example, the user decides to buy one of the products 416. In this manner, the system iteratively and recursively updates the product scores and ranks with each interaction by the user to provide real-time personalized product recommendations to the user.

The elicited preference information may be stored in the user profile database 110. The stored information may be used should the user return to the e-commerce website to view the same product or different products. The stored information also may be used across different e-commerce websites.

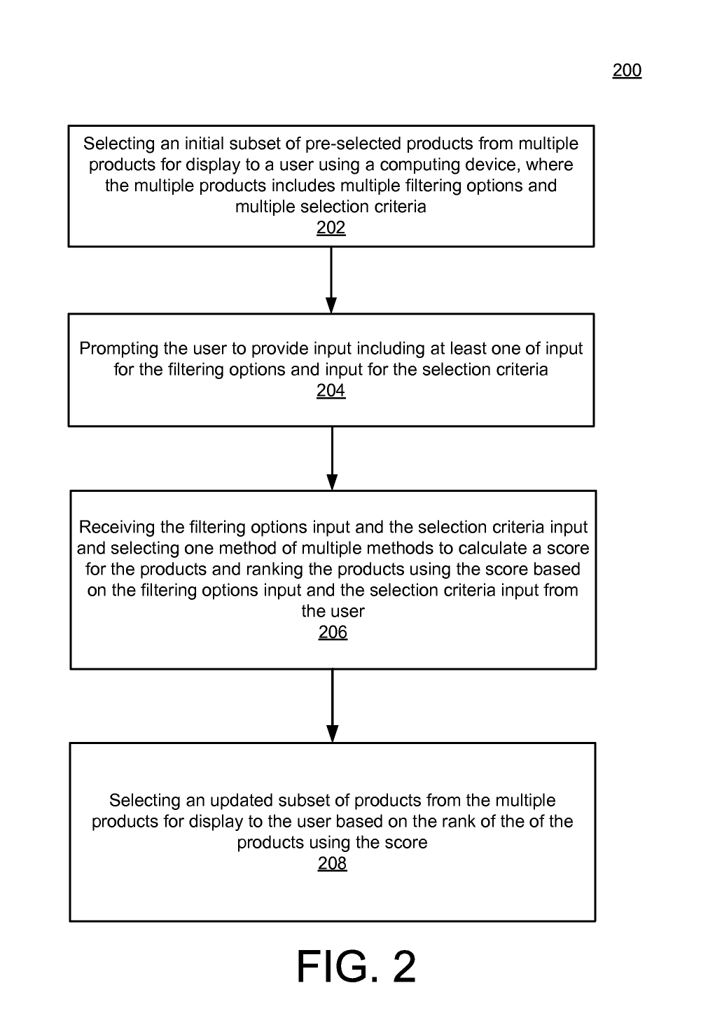

Referring to FIG. 2, an example process 200 illustrates example operations of the system 100 of FIG. 1. Process 200 includes selecting an initial subset of pre-selected products from multiple products for display to a user using a computing device, where the multiple products includes multiple filtering options and multiple selection criteria (202). For example, the option selection engine 104 is configured to select an initial subset of pre-selected products from multiple products for display to a user using a computing device, where the multiple products includes multiple filtering options and multiple selection criteria (202).

Process 200 includes prompting the user to provide input including at least one of input for the filtering options and input for the selection criteria (204). For example, the elicitation engine 106 is configured to prompt the user to provide input including at least one of input for the filtering options and input for the selection criteria (204).

Process 200 includes receiving the filtering options input and the selection criteria input and selecting one method of multiple methods to calculate a score for the products and ranking the products using the score based on the filtering options input and the selection criteria input from the user (206). For example, the ranking and scoring engine 108 is configured to receive the filtering options input and the selection criteria input and select one method of multiple methods to calculate a score for the products and rank the products using the score based on the filtering options input and the selection criteria input from the user (206).

Process 200 include selecting an updated subset of products from the multiple products for display to the user based on the rank of the of the products using the score (208). For example, the option selection engine 104 is configured to select an updated subset of products from the multiple products for display to the user based on the rank of the of the products using the score (208).

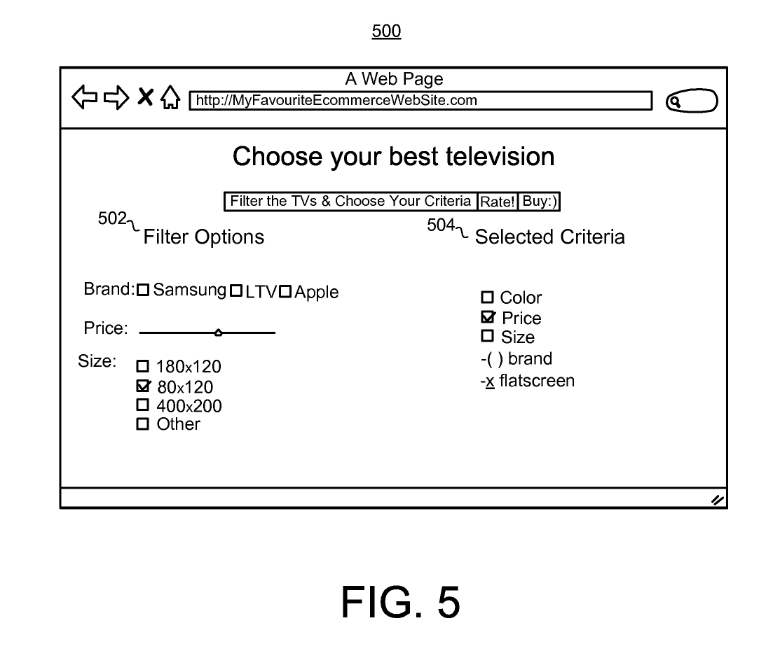

Referring to FIG. 5, an example screen shot 500 illustrates an example e-commerce website. In this example, the user is presented with filtering options 502 and selected criteria options 504. The filtering options 502 corresponds to the filtering options 402 of FIG. 4 and the selected criteria 504 corresponds to the selection criteria 404 of FIG. 4. In this example, the product category is televisions. As illustrated, the filtering options 502 relate to different features or attributes in the television category. The user is prompted by the elicitation engine 106 to provide input on options such as brand, price and size.

The elicitation engine 106 also prompts the user to provide input on which one or more of those options is important to the user in the selected criteria 504 list. For example, the user is invited to select one or more of the different criteria including color, price, size and brand. While there may be other types of filter options and selection criteria that could be displayed, the elicitation engine 106 may select only a subset of filter options and selection criteria to display to the user for input.

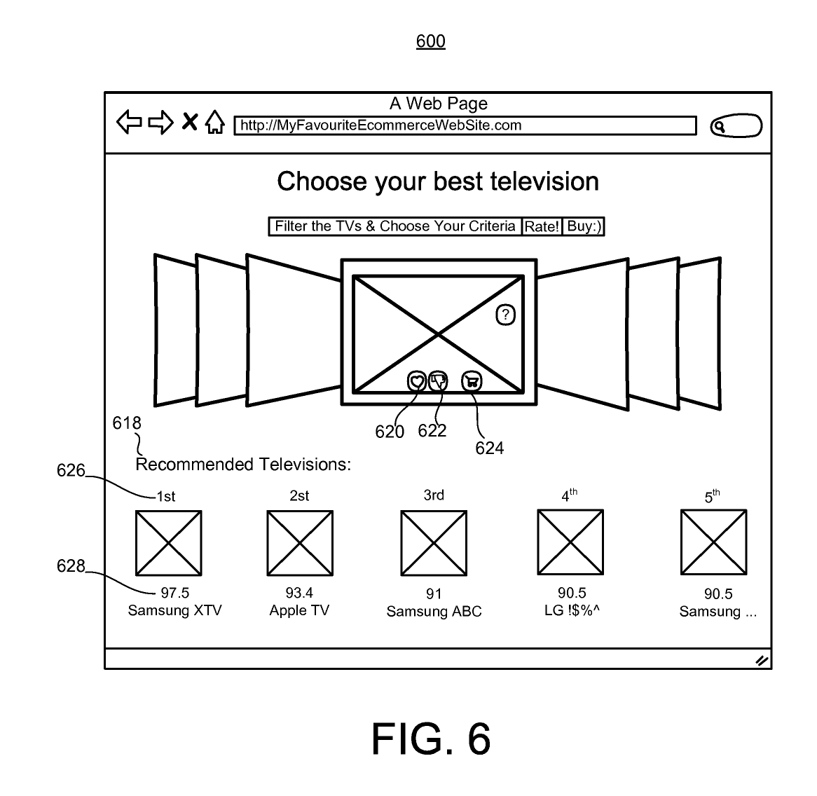

Referring to FIG. 6, an example screen shot 600 illustrates an example e-commerce website. In this example, the elicitation engine 106 has provided preference parameters to the ranking and scoring engine 108 and the ranking and scoring engine 108 has used the information from the elicitation engine 106 to calculate scores for the products and to rank the products based on the scores. The highest ranking products 618 may represent the personalized product recommendations for the user. These product recommendations 618 are displayed for the user to further interact with including options to like 620, dislike 622 or to buy 624 the displayed products.

The recommended products 618 may include a displayed ranking 626 for each product option and a displayed score 628 for each product. As the user further interacts with the displayed products by liking 620 or disliking 622 a certain product, then the system updates the scores and ranks of the products and displays and updated subset of recommended products.

As mentioned above, the ranking and scoring engine 108 may select one of multiple methods to calculate a score for the products. For example, if the user has specified a lesser amount of information or little information, then the system will, based on deduced constraints, elicit weights for the selected criteria. Based on these weights, a ranking method such as, for example, the weighted sum, can be used to score and rank the remaining product options. Additionally, the option selection engine 104 may display the weights for the selected criteria to the user so that the user can change and/or update the criteria and/or the weights associated with the criteria.

In another example, if the user has provided more information, then the system may have enough information to build a prediction or classification model (i.e., the learning set is big enough) which will be able to classify (or predict) all the remaining options into two categories: likes or dislikes. Furthermore, if a classification model outputs a probability of assignment for each prediction, such as a decision tree model, the system can rank and score all the remaining options. Also, for each classification model, the relevant features and their associated weights can be deduced and presented to the user.

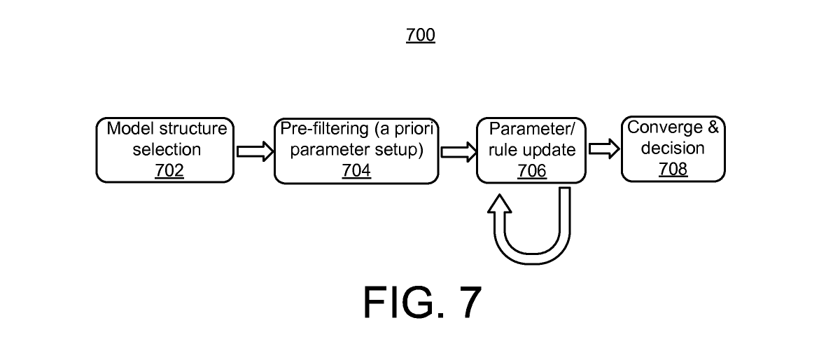

Referring to FIG. 7, an example block diagram illustrates an example flow 700 of user preference elicitation. As discussed above, the ranking and scoring engine 108 is configured to select a model structure 702. The selection of the model structure is based on the information provided by the elicitation engine 106. The elicitation engine 106 performs a pre-filtering 704 to determine which of the features are important to the user and then the elicitation engine 106 elicits weights from the user. The ranking and scoring engine 108 uses the parameters and rules to update the scores and rankings 706. Then, the option selection engine 104 converges and decides on the products to recommend 708 based on the scores and ranks of the products.

In one implementation, if the user has specified little information, a weighted ranking model may be used followed by a weight elicitation to elicit the weights of the features from the user. The weighted ranking model may be used by the ranking and scoring engine 108 to find out the meaningful criteria of the product which really affects the customer's buying, as well as the correct criteria weights which represent compromises the user makes between a products' different features.

Let us denote by fᵢ(Oⱼ) the i-th criterion which describes an option Oⱼ presented to the customer. The evaluations of the options will be noted as follows: fᵢ(Oⱼ) represents the evaluation of option j on feature i, which is similar to the utility function. In an equivalent way, the evaluation can be defined like this:

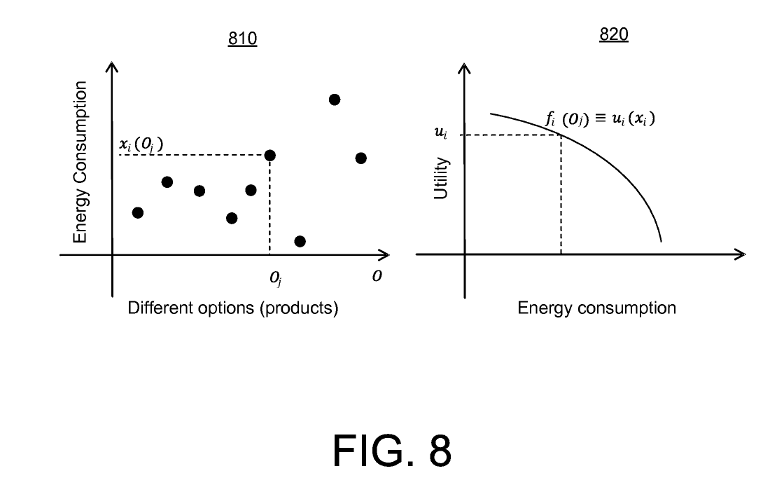

fᵢ(Oⱼ)≡uᵢ(xᵢ(Oⱼ))

where xᵢ(Oⱼ) denotes the i-th feature of Oⱼ, while uᵢ(xᵢ) defines the utility function of the feature xᵢ. Take the products of television for example, let xᵢ(Oⱼ), be the energy consumption of televisions, then the customer (or user) has an unique evaluation on the feature “energy consumption” of a specific television Oⱼ, resulting in criterion fᵢ(Oⱼ) illustrated in FIG. 8. FIG. 8 illustrates example graphs 810 and 820 of a user's evaluation of criterion.

The score associated to each option can be represented as follows:

$$S ( {O}_{j} ) = {S}_{j} = {\sum }_{∀ chosen criteria i} {w}_{i} * {f}_{i} ( {O}_{j} ) ≡ {\sum }_{∀ chosen criteria i} {w}_{i} * {u}_{i} ( {x}_{i} ( {O}_{j} ) )$$

where wᵢ represents the weigh on the i-th criterion.

The scores given to the objects must respect the customer preference constraint/definition:

S(Oⱼ₁)≦S(Oⱼ₂) [symbol] Oⱼ₁≲Oⱼ₂

where Oⱼ₁≲Oⱼ₂ means that the customer less or equally prefers Oⱼ₂ than Oⱼ₂. As one may notice in the previous formula, the score depends on the utility functions, which indeed are customer (i.e., user) dependent.

This leads to the next step, which is the weight elicitation process. To rank/score each option for the customer, the weight wᵢ for each user needs to be obtained. From the first step, i.e. option filtering, the range searching area of the options is reduced. When the customer gives further information of like/dislike on some particular products, these weights can be further estimated.

Methods are provided here for two different scenarios. In one example, the user's like/dislike on a set of products is used to elicit weight information and in another example, the user's preference on a set of product pairs provides the weight information.

In the first example, the customer's “like/dislike” on a set of products is used to elicit weight information. In this case, the customer gives scores on, for example, N options:

O₁: like, O₂: dislike, . . . , Oⱼ: like, . . . , O_{N}: dislike

Let like/dislike be logistic values 1/0, then a logistic regression may be carried out, that is:

{w₁, w₂, . . . , w_{L}}=LogisticRegression(S(Oⱼ)˜f₁(Oⱼ)+f₂(Oⱼ)+ . . . +f_{L}(Oⱼ)).

In the next example, the customer's “preference” on a set of product pairs provides the weight information. In this case, the customer gives choice on many pairs of options:

O₁₁≲O₁₂, O₂₁≲O₂₂, . . . , O_{N1}≲O_{N2}

Let like/dislike be logistic values 1/0, we can carry out a logistic regression, that is:

w*=[w₁*, w₂*, . . . , w_{L}*]=arg_{w} min w^{T}w

### Subject to

$$S ( {O}_{j 1} ) - S ( {O}_{j 2} ) = {\sum }_{i = 1}^{L} {w}_{i} * ( {u}_{i} ( {x}_{i} ( {O}_{j 1} ) ) - {u}_{i} ( {x}_{i} ( {O}_{j 2} ) ) ) \leq 0$$

To the preference constraint, one can add the following constraint which imposes that the utility functions is well ‘behaved’, i.e. monotonically decreasing and quasi-concave:

if S(Oⱼ₁)≦S(Oⱼ₂) and S(Oⱼ₁)≦S(Oⱼ₃) then Oⱼ₁≲θOⱼ₂+(1−θ)Oⱼ₂, θ∈[0,1]

The weight elicitation problem is a convex quadratic programming problem (QP) and can be solved efficiently with contemporarily solvers for numerical computation.

The customer may not have the patience to offer enough number choices, such that weights are well estimated. Therefore, one need to find as much information from not only the customer's choice but also his/her historical data as well as the average weight of a group of similar customers clustered by certain predefined criteria:

### Initialization and a Priori Information of Weights

If for example, a regression is made to obtain the weights of criteria, one can define the initial weight according to the customers/group historical behavior, and assign it with a certain confidence level, which forms the a priori distribution of the weight parameter. Using Bayesian inference can significantly improve the estimate.

### Recursive Estimation of Weights

As the customers are marking on the provided options, the elicitation engine 106 should not wait but make an estimation of weight immediately based on the current obtained data set, then the estimation procedure becomes a recursive update course of the weight. In regression methods, recursive estimation methods are one of the realizations of the algorithm.

The complete ranking/scoring model is explicated here below:

### Choosing Ranking/Scoring Model

1. Pre-filtering, set range of wᵢ, i=1, 2, . . . ,
2. Define ranking/scoring model:
   2.1 Define evaluation function (utility function) fᵢ(O), i=1, 2, . . . , L
   2.2 Pre-set weights w(0) and give its a priori distribution.
3. Recursive (on-line interactive) estimation of weights, when the customer is still searching for more options:
   3.1 Logistic regression: Customer's “like/dislike” on a set of products.
   3.2 (OR) Quadratic programming: Customer's “preference” on a set of product pairs.
4. If the customer buys one in the recommended options, quit recommendation, otherwise back to step 3.

Below is an optional procedure that will rank the n best options without scoring all the options. This enables to minimize the scoring time. But, this task is completely optional.

Both the utility function and its weight are assumed to be known or estimated, i.e. available. Then it reduces to (Prob. 1), which is solvable with convex optimization methods. For an example here, we can use interior point method, thus redefine an equivalent optimization problem:

$${O}_{{j}^{*}} = arg {min}_{{O}_{j}} - S ( {O}_{j} ) + {I}_{-} ( p ( {O}_{j} ) - B )$$

where I_(·) is defined as an indication function:

$${I}_{-} ( x ) = \{ \begin{matrix}0 & x \leq 0 \\ ∞ & x > 0\end{matrix}$$

while alternatively, one use a more smooth function with a positive t→∞:

$${O}_{{j}^{*}} = arg {min}_{{O}_{j}} - S ( {O}_{j} ) - \frac{1}{t} log ( B - p ( {O}_{j} ) )$$

Define the solution of the following problem, O_{c}*, as the central path:

$${O}_{{c}^{*}} = arg {min}_{{O}_{j}} - tS ( {O}_{j} ) - log ( B - p ( {O}_{j} ) )$$

Then, the barrier method can be used:

Given feasible Oⱼ, t: initialized positive, μ>1, tolerance ε>0

### While (1)

1. Centering:

$$Compute {O}_{{c}^{*}} for arg {min}_{{O}_{j}} - tS ( {O}_{j} ) - log ( B - p ( {O}_{j} ) )$$

2. Update O_{j*}=O_{c*}
3. If 1/t>ε, quit loop
4. Increase t by t=t*μ
5. Go to step 1

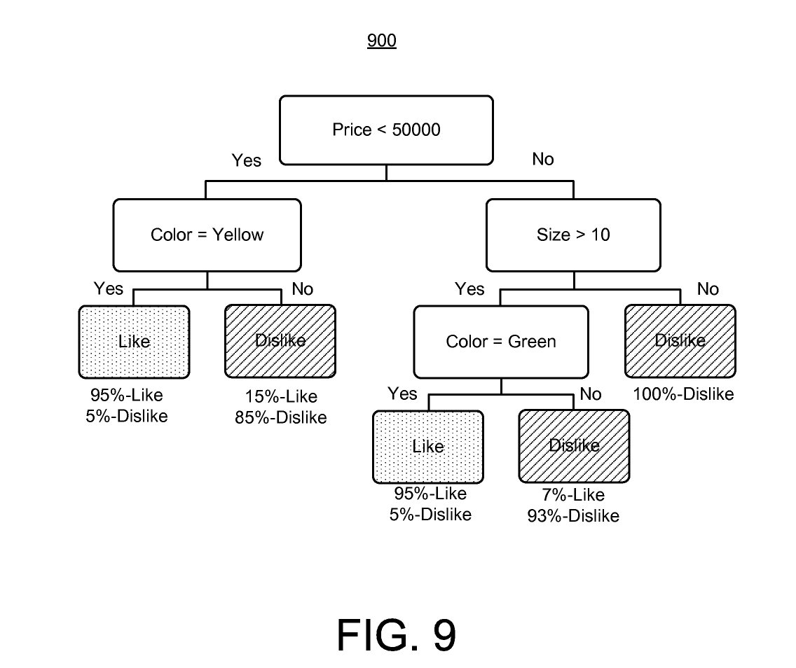

In some implementations, where the user has provided the system with enough information, then a valid and accurate predictive model may be trained. Based on the set of options that the user likes and dislikes a decision tree can be built as represented in FIG. 9. FIG. 9 illustrates an example schematic of an example decision tree 900. This decision tree elicits the ‘thinking path’ of a user and is able to predict if the user would like or dislikes new options. For instance, if a new object has a price higher than 50000 RMB, a size lower than 10 cm then the system should not recommend the user this option. Moreover, each leaf is associated with an assignment probability. This means that the assignment of any new option into one of the categories ‘like’ or ‘dislike’ can be estimated. In other words, any remaining available option can be scored (based on this probability) and thus ranked.

The use of the learning set will thus lead to the construction of a decision tree (this is thus the elicitation engine 106 which will build the decision tree) which enables the assignment of probabilities to the options (this is thus the ranking and scoring engine 108).

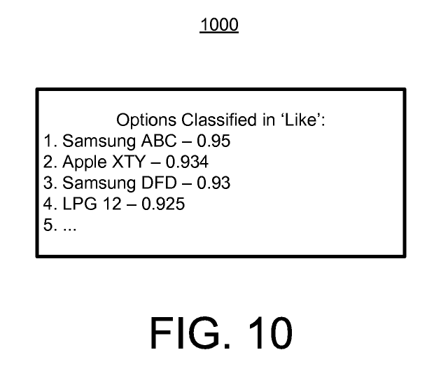

FIG. 10 is an example table 1000 of product options and associated scores.

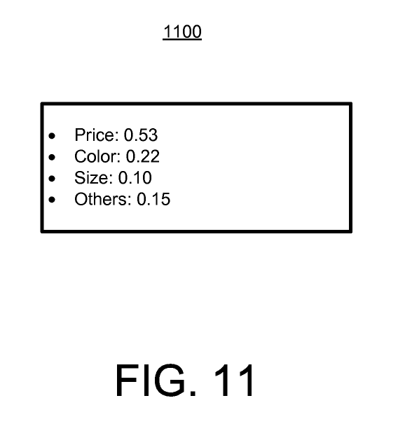

The proposed system enables to find out combination of filters (in or out) on the contrary of the usual filtering setting—the path from the root to the leaf, leading to the category ‘dislike’ can be considered as the combination of filters leading to this decision. Furthermore, when building the decision tree, the elicitation engine 106, will be able to provide the user with the relevant features/attributes as well as their associated weight as shown in FIG. 11.

FIG. 11 is an example table 1100 of features and associated weights. This can be achieved with e.g. Manhattan Hierarchical Cluster Criterion, feature extraction methods, or based on the GINI or Information gain when building the decision tree. This provides the user with insights into his/her the (elicited) importance of the features.

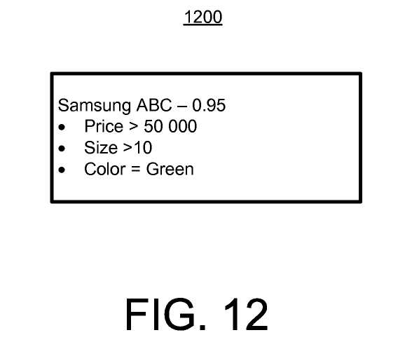

FIG. 12 is an example of a decision tree 1200 presented to a user. Furthermore, the use of a decision tree enables the user to understand easily why options are recommended (i.e. based on which features) by displaying the associated path leading to the assignment: for any rated option, the decision path can be explained and displayed. Below, follows an example of recommending the Samsung ABC which receives a score of 95%.

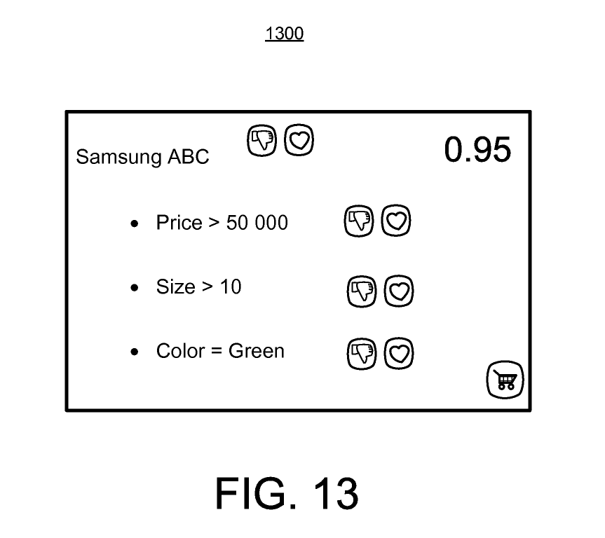

FIG. 13 is an example screen shot 1300 of a product and associated features. In the proposed system, the Ranking/Scoring of the remaining options will be associated with their path as well as some ‘like/dislike’ buttons for real time updating of the recommendations. The user will be able to like/dislike. In the former case, this new ‘labeled’ example can be added to the training set which means thus that the elicitation engine 106 can be invoked again as well as the ranking and scoring engine 108 (by training a new decision tree and re-scoring the remaining options). In the latter case, there exist different approaches to process the ‘feature condition’ information. Let us consider the following scenario: the user ‘dislikes’ the fact ‘Price>50 000’. The consequences are the following: All the available options which have a ‘Price>50 000’ are excluded from the recommended list of options. No option having this characteristic will be displayed to the user anymore. All the options (available options and the options from the learning set) which have a ‘Price>50000’ are ‘labeled’ as ‘dislike’ and a decision tree can be re-trained based on this new information. In other words, the recommendations are updated real-time according the users interactions which are saved in DB to create an in depth user-profile.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for providing personalized product recommendations to a user, the system comprising:
at least one memory including instructions; and
at least one processor that is operably coupled to the at least one memory and that is arranged and configured to execute the instructions that, when executed, cause the at least one processor to implement an elicitation engine, a ranking and scoring engine and an option selection engine, wherein:
the option selection engine is configured to select an initial subset of pre-selected products from a plurality of products for display to a user using a computing device, wherein the plurality of products includes a plurality of filtering options and a plurality of selection criteria,
the elicitation engine is configured to prompt the user to provide input including at least one of input for the filtering options and input for the selection criteria and to receive the filtering options input and the selection criteria input from the user;
the ranking and scoring engine is configured to receive the filtering options input and the selection criteria input and to select one method of multiple methods to calculate a score for the plurality of products and to rank the plurality of products using the score based on the filtering options input and the selection criteria input from the user, and
the option selection engine is configured to select an updated subset of products from the plurality of products for display to the user based on the rank of the of the products using the score.

2. The system of claim 1 wherein:
the elicitation engine receives filtering options input from the user; and
the ranking and scoring engine selects a weighted ranking method to calculate the scores for the plurality of the products using the filtering options input from the user.

3. The system of claim 2 wherein:
the elicitation engine is further configured to elicit either user likes and dislikes on a set of products displayed to the user or user preference information on a set of product pairs displayed to the user; and
the ranking and scoring engine is configured to recalculate the scores for the plurality of the products using either the user likes and dislikes on the set of products or the user preferences on the set of product pairs and to update the rank of the products using the recalculated scores.

4. The system of claim 2 wherein:
the elicitation engine receives filtering options input and selection criteria input from the user and calculates a predictive decision tree of product criteria; and
the ranking and scoring engine is configured to assign probabilities to the product criteria and to use the predictive decision tree and assigned probabilities to calculate the scores for the plurality of products and to rank the products using the scores.

5. The system of claim 4 wherein the elicitation engine is configured to display the product criteria and the associated weights to the user.

6. The system of claim 4 wherein the elicitation engine is configured to display a decision tree path for each of the plurality of products to the user.

7. The system of claim 6 wherein:
the elicitation engine is configured to receive additional inputs from the user using the displayed decision tree path; and
the ranking and scoring engine is configured to recalculate the scores for the plurality of the products using the additional inputs and to update the rank of the products using the recalculated scores.

8. The system of claim 7 wherein the inputs from the user are stored as a user profile in a database for future product scoring and ranking.

9. A computer program product, the computer program product being tangibly embodied on a non-transitory computer-readable storage medium and including instructions that, when executed, are configured to cause at least one processor to:
select an initial subset of pre-selected products from a plurality of products for display to a user using a computing device, wherein the plurality of products includes a plurality of filtering options and a plurality of selection criteria;
prompt the user to provide input including at least one of input for the filtering options and input for the selection criteria;
receive the filtering options input and the selection criteria input and select one method of multiple methods to calculate a score for the plurality of products and to rank the plurality of products using the score based on the filtering options input and the selection criteria input from the user, and
select an updated subset of products from the plurality of products for display to the user based on the rank of the of the products using the score.

10. The computer product of claim 9 further comprising instructions that, when executed, cause the processor to:
receive filtering options input from the user; and
select a weighted ranking method to calculate the scores for the plurality of the products using the filtering options input from the user.

11. The computer program product of claim 10 further comprising instructions that, when executed, cause the processor to:
elicit either user likes and dislikes on a set of products displayed to the user or user preference information on a set of product pairs displayed to the user; and
recalculate the scores for the plurality of the products using either the user likes and dislikes on the set of products or the user preferences on the set of product pairs and to update the rank of the products using the recalculated scores.

12. The computer program product of claim 10 further comprising instructions that, when executed, cause the processor to:
receive filtering options input and selection criteria input from the user and calculate a predictive decision tree of product criteria; and
assign probabilities to the product criteria and use the predictive decision tree and assigned probabilities to calculate the scores for the plurality of products and to rank the products using the scores.

13. The computer program product of claim 12 further comprising instructions that, when executed, cause the processor to display the product criteria and the associated weights to the user.

14. The computer program product of claim 12 further comprising instructions that, when executed, cause the processor to display a decision tree path for each of the plurality of products to the user.

15. The computer program product of claim 14 further comprising instructions that, when executed, cause the processor to:
receive additional inputs from the user using the displayed decision tree path; and
recalculate the scores for the plurality of the products using the additional inputs and to update the rank of the products using the recalculated scores.

16. The computer program product of claim 15 wherein the inputs from the user are stored as a user profile in a database for future product scoring and ranking.

17. A computer-implemented method for executing instructions stored on a non-transitory computer-readable storage medium, the method comprising:
selecting an initial subset of pre-selected products from a plurality of products for display to a user using a computing device, wherein the plurality of products includes a plurality of filtering options and a plurality of selection criteria;
prompting the user to provide input including at least one of input for the filtering options and input for the selection criteria;
receiving the filtering options input and the selection criteria input and selecting one method of multiple methods to calculate a score for the plurality of products and to rank the plurality of products using the score based on the filtering options input and the selection criteria input from the user; and
selecting an updated subset of products from the plurality of products for display to the user based on the rank of the of the products using the score.

18. The computer-implemented method of claim 17 further comprising:
receiving filtering options input from the user; and
selecting a weighted ranking method to calculate the scores for the plurality of the products using the filtering options input from the user.

19. The computer-implemented method of claim 18 further comprising:
receiving filtering options input and selection criteria input from the user and calculating a predictive decision tree of product criteria; and
assigning probabilities to the product criteria and using the predictive decision tree and assigned probabilities to calculate the scores for the plurality of products and to rank the products using the scores.

20. The computer-implemented method of claim 19 further comprising displaying the product criteria and the associated weights to the user
